(19) United States
(12) Patent Application Publication
(10) Pub. No.: US 2005/0028438 A1
(43) Pub. Date: Feb. 10, 2005

(54) Plastic lawn edging fabricated by a continuous vacuum forming process

(76) Inventor: Kimberly A. Campana, Sheffield Lake, OH (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/634,702

(22) Filed: Aug. 5, 2003

(51) Int. Cl. A01G 1/00

(52) U.S. Cl. 47/33

(57) ABSTRACT

A decorative lawn edging is disclosed which includes a plurality of blocks inter-connected together by living hinges. The front faces of the blocks include three-dimensional texture designs and the texture of the blocks can vary to provide a natural-looking simulated stone appearance. Methods of manufacturing the lawn edging using a continuous vacuum forming process or continuous blow molding process is also disclosed.

### TECHNICAL FIELD

A plastic lawn edging with a three-dimensional texture is disclosed. More specifically, a plastic lawn edging is disclosed whereby adjacent blocks are inter-connected by living hinges. Still more specifically, an upper portion of each block includes a three-dimensional texture and the lawn edging is fabricated using a continuous vacuum forming process.

### DESCRIPTION OF THE RELATED ART

Plastic lawn edging is known in the art. Such lawn edging has traditionally been manufactured using injection molding, blow molding and extrusion processes. Typically, extrusion manufactured plastic lawn edgings are a continuous elongated strip that is inserted into the ground along the desired border. Such continuous strips have limited decorative value.

Other decorative plastic lawn edging has been proposed which include discrete plastic block segments, designed to simulate a piece of stone, inter-connected together. However, because decorative lawn edging has only been manufactured using injection molding, blow molding and extrusion processes, the attempts to simulate stone blocks with plastic blocks has not been successful. Specifically, in injection molding, one mold cavity is typically used for several blocks of the lawn edging strip. Typically, the mold is capable of forming only three or four blocks and, as a result, the design can be duplicative and not natural looking. Further, because discrete connection pieces from the injection molding process is relied upon to connect one block segment to another, flexibility of the edging is limited and typically cannot be used for angles other than those predefined by molded connection pieces. Furthermore, deflection at other angles in injection molded or blow molded pieces induces significant stress into the pieces, decreasing the integrity of the overall product. This problem also exists with blow molding techniques. Extrusion molding does not allow for decorative faces and therefore has limited value.

Further, injection molding requires a single mold cavity which can produce a single part at a time during a given molding cycle. Each cycle takes a predetermined amount of time to complete. The mold must be opened and closed for each discrete cycle. Injection molding is also performed at high pressures, which limits productivity. Also, to change the characteristic of a part molded with injection molding equipment requires shutting down the machinery, altering or replacing the mold or mold cavities and restarting. Sometimes simple changes to materials, wall thickness or part length can require serious modification to the equipment or complete mold cavity replacement. The same drawbacks are also present in blow molding and extrusion blow molding techniques.

When fabricating a three-dimensional decorative lawn edging design using any of the above processes, a hole or vent in each block must be provided for. When the hole or vent is disposed on the rear face of each block, it becomes visible when the edging is placed around corners or bends.

Therefore, there is a need for an improved plastic decorative lawn edging design which avoids identical adjacent blocks inter-connected together or short patterns of blocks inter-connected together and which further avoids the display of an unsightly vent or hole along the back of each block. Further, there is a need for an improved process for manufacturing such a lawn edging which avoids the deficiencies of injection molding, blow molding and extrusion blow molding described above.

### SUMMARY OF THE DISCLOSURE

In satisfaction of the aforenoted needs, an improved plastic decorative lawn edging is disclosed.

Further, an improved method of manufacturing or fabricating a plastic decorative lawn edging is also disclosed.

### BRIEF DESCRIPTION OF THE DRAWINGS

The disclosed decorative lawn edging and method of manufacture thereof are described in detail in the following description in conjunction with the attached drawings: wherein

FIG. 1 is a front plan view of a set of lawn edging blocks inter-connected together by living hinges;

FIG. 2 is a partial enlarged front plan view of the lawn edging shown in FIG. 1;

FIG. 2a is a sectional view taken substantially along 2A-2A of FIG. 2;

FIG. 3 is a perspective view of the lawn edging shown in FIG. 1 in a curved position illustrating the flexibility provided by the living hinges that connect the adjacent blocks;

FIG. 4 is another perspective view of the lawn edging shown in FIG. 1 illustrating two blocks at an approximate 90° with respect to each other and other blocks in a curved configuration, similar to that shown in FIG. 3;

FIG. 5 is a partial perspective view of another embodiment of a decorative lawn edging made in accordance with this disclosure particularly illustrating blocks with lower portions having a plurality of ribs and a barbed rib for improved ground anchoring function;

FIG. 5A is a sectional view taken substantially along line 5A-5A of FIG. 5;

FIG. 6 is a front elevation and schematic view of one example of a machinery designed to practice the disclosed method of manufacturing continuous decorative plastic lawn edging;

FIG. 7 is a schematic end view of a pair of mold blocks used in the machinery shown in FIG. 6; and

FIG. 8 illustrates another example of a mold portion of a machinery set up to practice the disclosed method for manufacturing plastic decorative continuous lawn edging.

### DETAILED DESCRIPTION OF THE PRESENTLY PREFERRED EMBODIMENTS

The structures and methods described herein in accordance with the teachings of this disclosure solve or improve upon the problems and limitations described above, as well as other deficiencies, that are known from prior art decorative lawn edgings and methods of manufacture. For example, the disclosed method permits a continuous formation of a string of inter-connected decorative lawn edging blocks and living hinges connecting adjacent blocks that can be cut or separated into discrete segments of lawn edging. The disclosed method permits formation of inter-connected block segments each having discrete features previously capable of being formed using only intermittent or non-continuous molding processes.

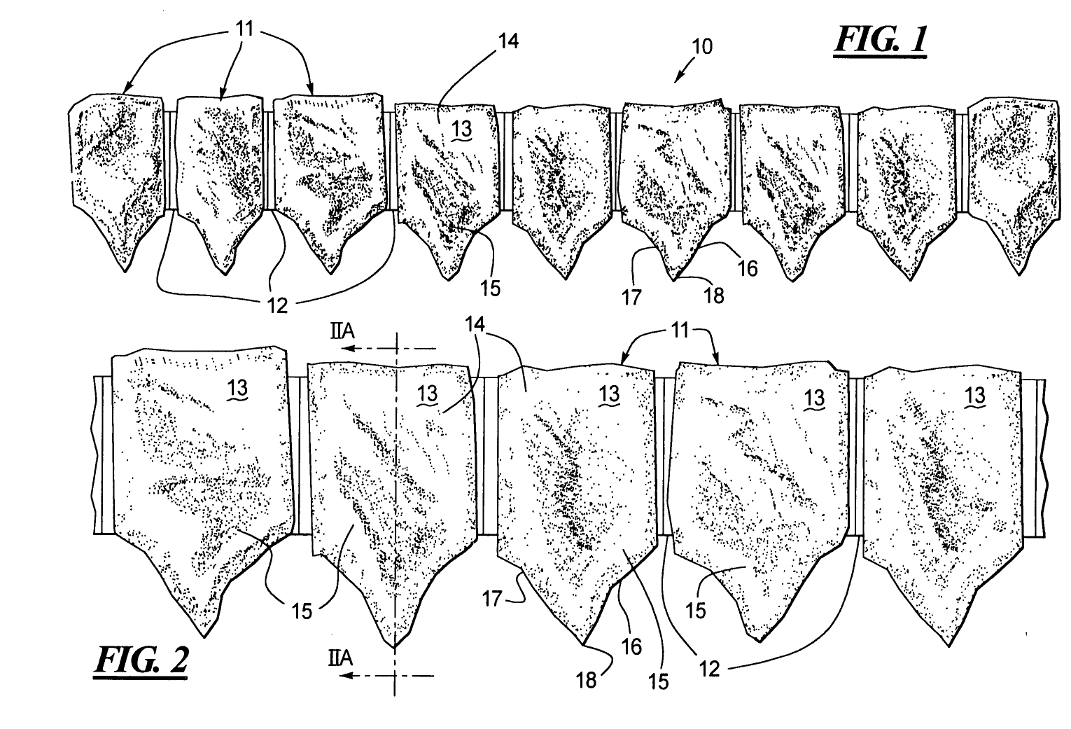

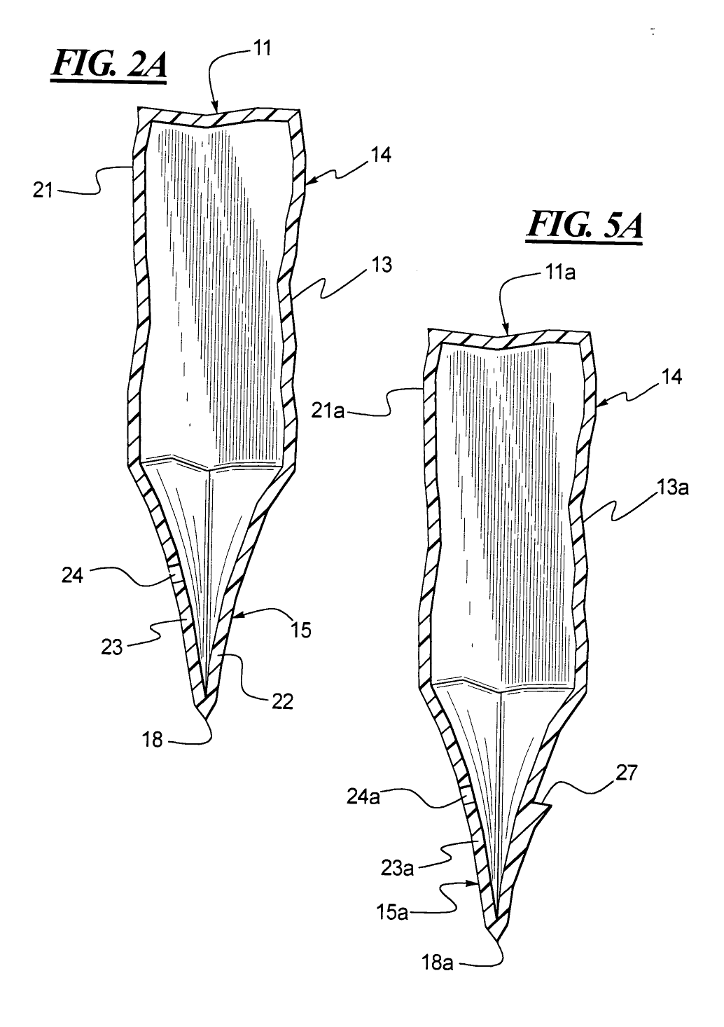

Turning to FIG. 1, a lawn edging strip 10 is illustrated which includes a plurality of inter-connected blocks 11 that are connected to one another by way of living hinges 12. Referring to FIGS. 1 and 2 together, each block 11 includes a front face 13 with a three-dimensional textured pattern. Each block 11 also includes an upper section 14 and a lower section 15. The lower section 15 includes lower edges 16, 17 that extend toward each other and terminate at a downwardly directed point 18 so that the lower portions 15 of the block 11 can be easily anchored into the ground (not shown).

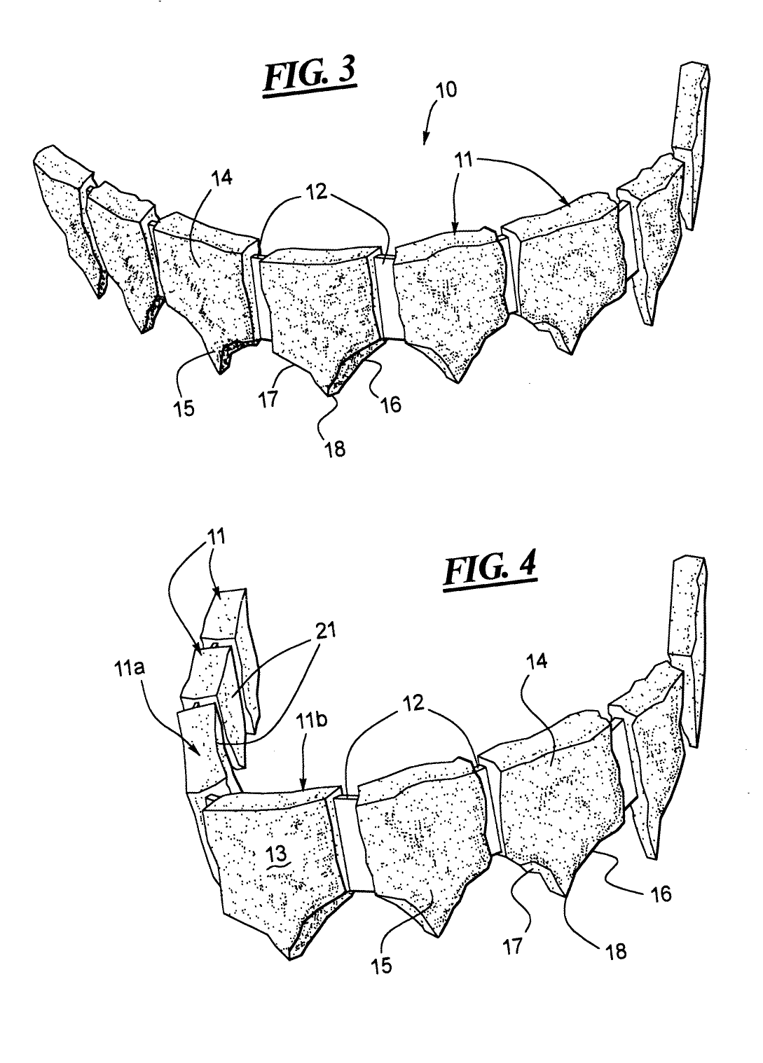

As shown in FIGS. 3 and 4, the living hinges 12 provide excellent flexibility between adjacent blocks 11. Specifically, the blocks 11 as shown in FIG. 3 can be arranged in a curved position or, two blocks such as those shown at 11a, 11b in FIG. 4 can be arranged at a 90° or right angle with respect to each other. In addition, as shown FIG. 4, the front surface 13 of each block 11 can have a three-dimensional texture and, the rear surface 21 of each block 11 may also include a three-dimensional textured design as well so that as a block extends around a sharp turn or corner, and the rear surfaces 21 of the blocks 11 become visible, a textured design will be presented to the viewer.

Turning to FIG. 2A, a side sectional view of a block 11 is illustrated. The front face 13 of the upper section 14 includes a three-dimensional texture to simulate a piece of stone, such as sand stone or other rough rock, brick, wood or other decorative designs. Similarly, a texture may be provided for the rear surface 21 of the upper portion 14 so that when the rear surface is visible, such as in the configuration shown in FIG. 4, the viewer will see a natural looking surface. In addition to the lower edges 16, 17 illustrated in FIGS. 1-4, the lower section 15 also includes a front wall 22 and a rear wall 23 that extend toward each other before meeting at the point 18 to provide a tooth-shaped blade for anchoring the lawn edging 10 into the ground. The rear wall 23 of the lower portion 15 is a convenient place for a vent hole 24.

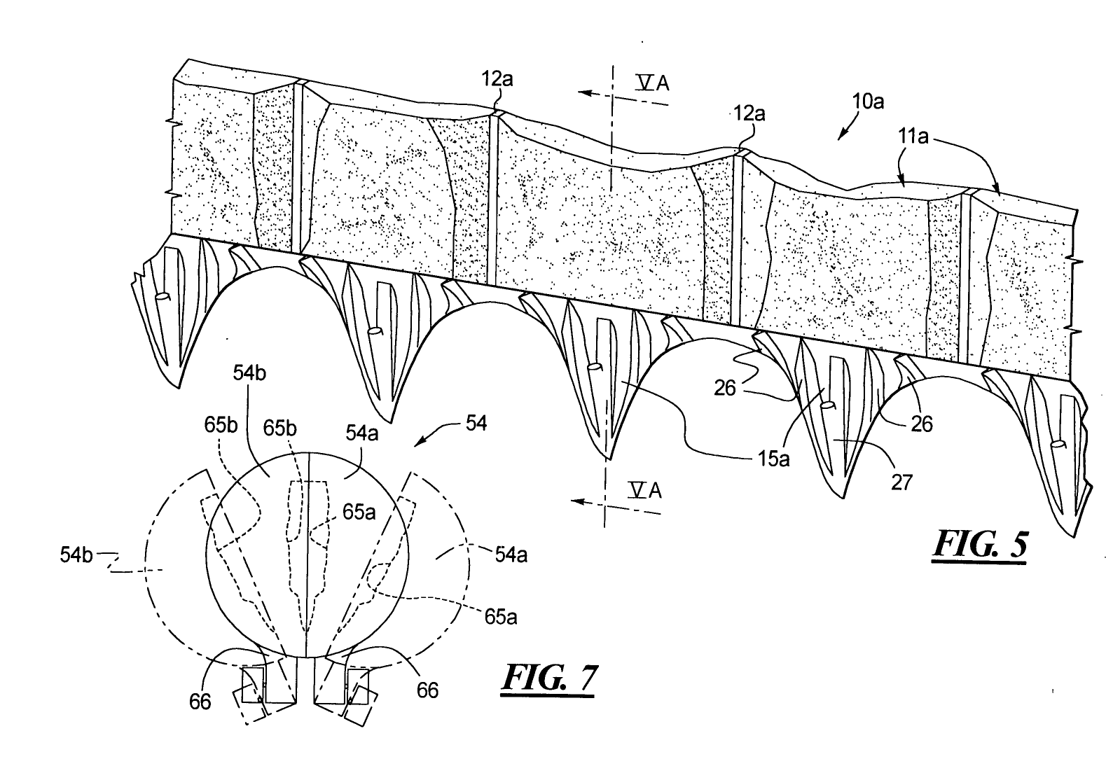

Turning to FIG. 5, an alternative strip 10a of lawn edging is disclosed wherein the lower portions 15a of each block 11a include a plurality of ribs shown at 26, one or more of which can be a barbed rib as shown at 27. The ribs 26 provide structural integrity for the lower portion 15a which is thinner than the upper portion 14 as shown in FIG. 5A and the one or more barbed ribs 27 also has an anchoring effect when the lower portion 15 is inserted into the ground. Further, the rear wall 23a is a convenient place for a vent hole 24a. Three-dimensional texture surfaces may be provided at the front surface 13a as well as the rear surface 21a.

The living hinges 12 illustrated in FIGS. 1-4 and 12a illustrated in FIG. 5 are not mere flashing generating by molding the adjacent blocks 11 and 11a. Instead, they are molded with the blocks and have sufficient thickness for durability yet are sufficiently thin to provide the requisite flexibility as illustrated in FIGS. 3 and 4. As shown in FIGS. 2a, 5 and 5a, the lower portions 15, 15a are recessed or thinner than the upper portions 14, 14a. In addition to providing structural integrity, the ribs 26, 27 as shown in FIG. 5 will also facilitate dislodgment of the lawn edging 10a from the ground even after a sufficient amount of soil compaction has occurred. Further, as shown in FIG. 12a, the hinge 12a may include a hole for accommodating an anchoring stake to facilitate securing the edging 10a in place.

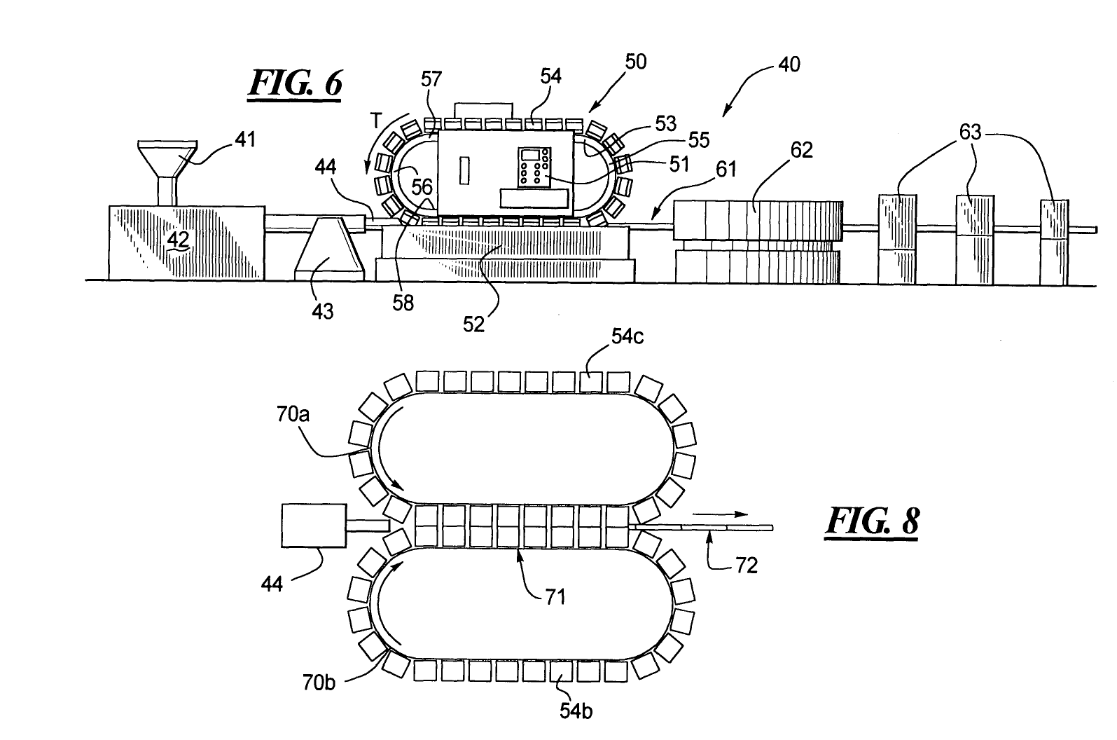

Turning to FIGS. 6-8, a method of manufacturing the edgings 10, 10a will now be described. A continuous molding machine 40 is illustrated in FIG. 6. The machine 40 is a hybrid of technologies including plastic extrusion and vacuum forming or blow molding. As shown in FIG. 4, the machine 40 includes a hopper 41 for feeding material into an extruder 42. An additional extruder 43 may also be utilized for multi-material molding. The extruder 43 would also include a hopper (not shown). The hopper 41 delivers plastic material, usually in the form of pellets, to the extruder 42 which heats and mixes the bulk material. The heated and mixed material, when ready, is fed to an extrusion die 44 from which an extruded stream of molten plastic is ejected.

The molten stream of plastic is fed to an upstream end of a continuous forming machine 50 which, in one form, is known in the art as a pipe corrugator for forming continuous lengths of corrugated drainage pipe and like. Such a machine is known for forming continuous lengths of plastic corrugated pipe from high density polyethylene (HDPE), a relatively soft, non-brittle material. However, it has not been known to utilize such a machine for fabricating other types of products, such as lawn edgings, which discrete but inter-connected blocks. It has also not been considered to utilize such a machine to mold much more brittle homopolymers such as propylene and other plastics.

The forming machine 50 includes a control panel 51 and is supported by a base 52 which may be used to house elements of the machine including motors, vacuum pumps, air compressors or the like.

The forming machine 50 has a continuous track 53 arranged in a circuitous path, such as an oval track as shown in the example illustrated in FIG. 6. The track 53 lies generally parallel to horizontal in this example. A plurality of mold segments 54 are carried on and conveyed along the continuous track 53 in the direction of the arrow T.

In the example illustrated in FIGS. 6 and 7, the mold segments 54 each include two mold halves 54a, 54b that open and close in a clam-shell manner. In operation, the mold segment pairs are open while traveling around the curved end sections 55, 56 and upper linear section 57 of the track 53. The mold segment pairs 54 then close onto the continuous molten stream of plastic while traveling along the bottom linear section or molding section 58 of the track 53.

The molten stream of plastic is conformed to the mold cavities 54 and within the mold segments 54a, 54b as they travel along the molding section 58 of the track 53. A continuous train 61 of inter-connected blocks 11 or 11a is ejected from the downstream end (right-hand side of forming machine 50 as shown in FIG. 4) and is passed to a cooling apparatus 62. In one example, the cooling apparatus 62 is a water bath utilizing cool water jets, for example, to cool the continuous train of lawn edging blocks 61. The cooling apparatus 62 can alternatively be an air cooling bath in which cool air is moved over the continuous train 61. As will be evident to those having ordinary skill in the art, the cooling apparatus 62 may vary considerably without departing from the spirit and scope of this disclosure.

In one example, the mold segments 54 entering the molding section 58 of the track 53 are heated. The molds segments can be cooled as they approach the downstream end where the mold segments will be opened to release the continuous train 61 of lawn edging 10, 10a. Thus, the mold segments 54 themselves can, in one example, be used to assist in the cooling of the continuous train 61 of lawn edging 10.

As generally identified as 63 in FIG. 6, the downstream operations can be performed in a continuous train, as necessary. For example, flash removal, cutting and packaging operations can be incorporated. Ultimately, the continuous train 61 of lawn edging is cut into segments of a desired length.

In order to form the continuous train 61 of lawn edging 10 from the extruded stream of plastic, a pressure differential is applied to the plastic material within the mold cavities 65a, 65b (see FIG. 7) of the mold segments 54 while traveling along the molding section 58 of the track 53. In one example, a vacuum or negative pressure can be applied at the mold cavity surfaces 65a, 65b within the mold segments 54 as they travel along the molding section 58. As noted above, vacuum pumps (not shown) can be provided as a part of the forming machine 50. The vacuum or negative pressure draws the extruded plastic material against the cavity walls 65a, 65b to form the blocks 11, 11a and hinges 12, 12a.

In an alternative example, a positive pressure (i.e., blow mold type flow) can be applied internally to the molten stream of plastic in order to force the plastic material against the mold cavity walls 65a, 65b. This can be accomplished in a number of ways. The air pressure can be blown through the molten stream plastic at the extrusion dye 44 or it can blown into the extruded stream plastic as it is captured between the closed mold segments 54 in the molding section 58. This can be done by piercing the stream of plastic with a small needle within the mold cavity and forcing air through the needle into the plastic stream. Other methods of applying a pressure differential to the molten stream will be apparent to those skilled in the art.

As further shown in FIG. 7, the mold segment pair 56a, 56b is shown in a closed position and solid line and in an open position in phantom. Though not necessary, the mold segments 54a, 54b may include mounting ears 66 extending from the segment 54 which can be received in guides in the track 53. The position and orientation of the guides in the track change in order to open and close the mold segment pairs 54a, 54b at the appropriate location, i.e., closing as the mold segments 54 reach the molding section 58 and opening as the mold segments 54 reach the downstream end of the molding section 58 or the curved section 55 of the track 53.

As illustrated in FIGS. 6 and 8, a plurality of molds 54 are utilized. Thus, each mold may be unique thereby imparting different textured surfaces 13 and 21 to the blocks 11 to provide a non-uniform appearance for adjacent blocks 11. As shown in FIG. 6, the mold segments 54 are easily accessible and may be changed with relative ease. In other words, mold segments 54 may be easily swapped for other mold segments to change the look and feel of the produced lawn edging 10, 10a.

As an alternative, instead of the single circuitous path with clam-shell type operation as shown in FIG. 6, two tracks 70a, 70b may be provided which rotate in opposite (i.e., counter-clockwise—70a and clockwise—70b) directions as shown in FIG. 8. The tracks 70a, 70b carry a plurality of mold cavities 54c, 54d that engage each other and close along the molding section 71 and depart from one another and open downstream of the molding section 71 to provide a continuous train 72 of lawn edging.

The disclosed process is extremely flexible, relatively inexpensive to run, highly efficient in fabricating lawn edgings in a continuous manner, and can reduce overall manufacturing costs and production time significantly, once the initial outlay for the machine 40 is made.

Although certain methods in lawn edging designs have been described herein in accordance with the teachings of the present disclosure, the scope and coverage of this patent is not limited thereto. On the contrary, this patent covers all embodiments of the teachings of the disclosure that fairly fall within the scope of the appended claims and the equivalence thereto.

1. A plastic simulated rock lawn edging comprising:
a plurality of hollow middle blocks and two hollow end blocks,
each middle block being disposed between and connected to two other middle blocks or one other middle block and one of the end blocks by a living hinge,
each middle and end block including an upper portion and a lower portion, each upper portion including a front face comprising a three-dimensional simulated rock texture, each lower portion being tapered.

2. The lawn edging of claim 1 wherein the lower portion of each block further includes two side edges that extend inwardly towards each other as they extend downward from the upper portion, the lower portion further including a front face and the rear face, at least one of the front or rear faces of the lower portion including a barbed rib.

3. (Cancelled)

4. The lawn edging of claim 1 wherein the lawn edging is fabricated by a continuous vacuum forming process.

5. The lawn edging of claim 1 wherein the living hinges permit two adjacent blocks to be positioned at an angle with respect to each other ranging from about 180° to about 90°.

6. The lawn edging of claim 1 wherein each of the blocks also comprise a pressure equalization hole.

7. The lawn edging of claim 1 wherein the blocks and living hinges are formed from two or more plastic materials.

8. The lawn edging of claim 1 wherein the blocks and living hinges are fabricated from one or more plastic materials are selected from the group consisting of linear low density polyethylene, polyvinylchloride, polyethyleneterephthalate, polypropylene and mixtures thereof.

9. The lawn edging of claim 1 wherein the lower portion of each block further includes two side edges that extend inwardly towards each other as they extend downward from the upper portion, the lower portion further including a front face and the rear face that extend towards each other as they extend downward from the upper portion.

10. A method of fabricating a lawn edging, the method comprising:
providing a plurality of openable and closable mold segments arranged end to end along a continuous path, each mold segment providing a mold for a block of the lawn edging;
circulating a plurality of mold segments through multiple revolutions of the continuous path such that the mold segments are closed while traveling along a molding section of the continuous path;
continuously extruding a molten stream of plastic at an upstream end of the molding section and into mold cavities of the closed or closing mold segments;
applying a pressure differential to the mold cavities of the closed mold segments to conform the molten stream of plastic to the mold cavities;
ejecting a continuous train of inter-connected blocks to a downstream end of the molding section, the blocks being inter-connected by flashing material that serves as living hinges for inter-connecting the blocks together; and
separating a discrete set of lawn edging blocks from the continuous train by cutting the living hinge between two blocks.

11. A method according to claim 10, further comprising the step of cooling the inter-connected blocks.

12. A method according to claim 11, wherein the stop of cooling is performed on the continuous train of inter-connected blocks.

13. A method according to claim 11, wherein the step of cooling is performed on the discrete set of lawn edging segments after the step of separating.

14. A method according to claim 11, wherein the step of cooling includes passing the continuous train of inter-connected blocks through a water bath.

15. A method according to claim 10, wherein the step of providing a plurality of mold segments further comprises a plurality of operable and closable mold segment pairs.

16. A method according to claim 15, wherein the step of circulating further comprises circulating the mold segment pairs around at least one continuous track through a plurality of revolutions, and wherein the plurality of mold segment pairs are closed while in the molding section and opened when not in the molding section during each revolution.

17. A method according to claim 16, wherein the mold segment pairs are carried on a pair of adjacent continuous tracks circulating in opposite directions, one mold segment of each pair carried on a respective one of the pair of tracks, and wherein the pair of tracks are arranged generally in the same plane which is generally parallel to horizontal.

18. A method according to claim 10, wherein the step of extruding further comprises extruding multiple streams of molten plastic concentric to one another to form multi-layered blocks and living hinges.

19. A method according to claim 18, wherein the step of extruding further comprises extruding at least two different molten plastic material streams.

20. A method according to claim 18, wherein the step of extruding further comprises extruding at least two different color molten plastic material streams.

21. A method according to claim 10, wherein the step of applying a pressure differential further comprises applying a negative pressure to mold cavity surfaces within the mold cavities when in the molding section.

22. A method according to claim 21, wherein the step of applying a pressure differential further comprises applying a positive pressure within the stream of molten plastic when in the molding section.

23. A method according to claim 10, wherein the step of circulating further comprises coupling a plurality of mold segment pairs to at least one circuitous track, and circulating the at least one circuitous track through multiple revolutions to sequentially close and open the plurality of mold segment pairs at least once during each revolution.

24. A method according to claim 23, wherein the step of circulating opens and closes the plurality of mold segment pairs in a clam-shall manner.

25. A method according to claim 16, wherein the step of circulating further comprises coupling each mold segment of the plurality of mold segment pairs to a respective track of a pair of circuitous tracks, the pair of tracks arranged generally parallel to one another in the same horizontal or vertical plane, and circulating each of the pair of circuitous tracks in opposite directions to sequentially close and open the plurality of mold segment pairs.

26. A method according to claim 10, further comprising the steps of:
re-opening the closed mold segments at a downstream end of the molding section; and
discharging the continuous train of inter-connected blocks from the mold segments during the step of re-opening.

27. A method according to claim 10, wherein the mold segments define mold cavities that are non-identical to produce a continuous train of different inter-connected blocks.

28. A method according to claim 10, wherein the step of applying a pressure differential further comprises applying a vacuum to each of the discrete mold cavities of the closed mold segments.

29. A lawn edging comprising a discrete set of inter-connected blocks made in accordance with the method of claim 10.

30. A plastic simulated rock lawn edging comprising:
a plurality of hollow middle blocks and two hollow end blocks,
each middle block being disposed between and connected to two other middle blocks or one other middle block and one of the end blocks by a living hinge,
each middle and end block including an upper portion and a lower portion, each upper portion including a front face comprising a three-dimensional simulated rock texture, each lower portion being tapered,
wherein the lower portion of each block further includes two side edges that extend inwardly towards each other as they extend downward from the upper portion, the lower portion further including a front face and the rear face, at least one of the front or rear faces of the lower portion including a barbed rib.

31. The lawn edging of claim 30, wherein the middle and end blocks are hollow.

32. The lawn edging of claim 31 wherein the lawn edging is fabricated by a continuous vacuum forming process.

33. The lawn edging of claim 32 wherein the living hinges permit two adjacent blocks to be positioned at an angle with respect to each other ranging from about 180° to about 90°.

34. The lawn edging of claim 33 wherein each of the blocks also comprise a pressure equalization hole.

35. The lawn edging of claim 34 wherein the blocks and living hinges are formed from two or more plastic materials.

36. The lawn edging of claim 33 wherein the blocks and living hinges are fabricated from one or more plastic materials are selected from the group consisting of linear low density polyethylene, polyvinylchloride, polyethyleneterephthalate, polypropylene and mixtures thereof.

37. A plastic simulated rock lawn edging comprising:
a plurality of hollow middle blocks and two hollow end blocks,
each middle block being disposed between and connected to two other middle blocks or one other middle block and one of the end blocks by a living hinge,
each middle and end block including an upper portion and a lower portion, each upper portion including a front face comprising a three-dimensional simulated rock texture, each lower portion being tapered,
wherein the lower portion of each block further includes two side edges that extend inwardly towards each other as they extend downward from the upper portion, the lower portion further including a front face and the rear face that extend towards each other as they extend downward from the upper portion.

38. The lawn edging of claim 37, wherein the middle and end blocks are hollow.

39. The lawn edging of claim 38 wherein the lawn edging is fabricated by a continuous vacuum forming process.

40. The lawn edging of claim 39 wherein the living hinges permit two adjacent blocks to be positioned at an angle with respect to each other ranging from about 180° to about 90°.

41. The lawn edging of claim 40 wherein each of the blocks also comprise a pressure equalization hole.

42. The lawn edging of claim 41 wherein the blocks and living hinges are formed from two or more plastic materials.

43. The lawn edging of claim 42 wherein the blocks and living hinges are fabricated from one or more plastic materials are selected from the group consisting of linear low density polyethylene, polyvinylchloride, polyethyleneterephthalate, polypropylene and mixtures thereof.
